(19) United States
(12) Patent Application Publication
(10) Pub. No.: US 2019/0127123 A1
(43) Pub. Date: May 2, 2019

(54) Tamper Evident Closure, Container with the Closure, and Method for Screwing the Closure onto a Container

(71) Applicant: Anheuser-Busch InBev S.A., Brussels (BE)

(72) Inventors: Stephen Jones, St. Louis, MO (US); Brian Pincus, St. Louis, MO (US)

(21) Appl. No.: 16/097,811

(22) PCT Filed: May 4, 2017
(86) PCT No.: PCT/EP2017/060713

§ 371 Date: Oct. 30, 2018

Related U.S. Application Data
(60) Provisional application No. 62/332,979, filed on May 6, 2016.

(51) Int. Cl. B65D 41/34; B67B 3/18; B65D 1/02; B67B 3/20

(52) U.S. Cl. CPC B65D 41/349; B67B 3/18; B65D 81/267; B65D 1/0207; B67B 3/20; B65D 1/0246

(57) ABSTRACT

A method for securing a tamper evident closure to a container includes providing a pre-threaded closure that is defined by a top portion and a skirt portion that extends from the top portion. The skirt portion defines an inner closure thread surface and an opposed outer closure thread surface of at least one closure thread. The skirt portion also includes a tamper evident band. The pre-threaded closure is rotated to engage the at least one closure thread with at least one container thread of a container. The inner closure thread surface contacts a surface of the at least one container thread. The tamper evident band of the pre-threaded closure is rolled to secure the tamper evident band to the container.

### PRIORITY CLAIM

This application claims priority to U.S. Provisional Patent Application Ser. No. 62/332,979, filed on May 6, 2016, the disclosure of which is hereby incorporated by reference.

### TECHNICAL FIELD

This disclosure relates in general to closures for containers and, in particular, but not by way of limitation, to a prethreaded closure with a tamper evident band that is screwed onto a threaded bottle.

### BACKGROUND

It is known to use threaded closures to close and seal beverage bottles. The closures have multiple functions. The closure provides the seal to keep the beverage in the container. In addition, the closure serves to keep the beverage fresh, keep oxygen out of the beverage, and keep carbon dioxide, in the form of carbonation, in the beverage. Once the closure is removed by the consumer, if it is a threaded closure, it can be replaced. It is important for these types of closures to have features that indicate that the closure has been removed. U.S. Pat. No. 2,367,317, to John W. Thomas filed on Jul. 4, 1942 and entitled “Closure,” which is hereby incorporated by reference discloses a threaded aluminum closure with a crimped tamper evident band. The threads allow the closure to be reclosable. When the closure is twisted off the threads of the bottle, the twisting action fractures preformed bridges in the closure and separates a cap portion of the closure from the tamper evident band, which may also be referred to as a pilfer-proof band. The closure is unscrewed and removed from the container, but the pilfer proof/tamper evident band remains crimped or otherwise secured to the container. Thus, if a consumer gets a bottle where the cap portion of the closure has already been fractured from the tamper evident band, the consumer knows that the bottle has been tampered with and may not be safe for consumption. In this manner, the pilfer-proof feature provides an indication to the consumer that the closure was applied by the filler after filing the bottle, and the bottle has remained sealed until opened by the consumer.

Another example of a tamper evident feature of conventional threaded closures is described in U.S. Pat. No. 5,891,380, to LaRue, which is hereby incorporated by reference. This closure includes vertical slits disposed circumferentially around a bottom portion of the skirt that flare outward upon initial removal of the closure. The vertically slitted band is removed with the closure but if rethreaded to the container, the flared configuration of the vertically slitted band indicates to the consumer that the closure has previously been removed.

Conventional metal closures are often referred to as roll-on pilfer proof (“ROPP”) closures. ROPP refers to the tamper evident band and also refers to how the closure is applied to the container. The closure is rolled-on. This refers to the action of applying an axial force to hold the closure to the container and employing forming rollers that revolve around the closure and form the skirt portion to conform to the threads of the container. The container may be glass, plastic, or aluminum. A second set of forming rollers roll the tamper evident band to the container.

Wine makers sometimes close wine bottles with threaded closures. Because threaded closures for wine have historically indicated low quality, wine makers required a closure that is threaded but the closure threads are hidden from view until the closure is removed. U.S. Pat. No. 7,922,018 to Jacques Granger et al., filed on Dec. 21, 2005 and entitled “Bottle Closure with Improved Thread,” which is hereby incorporated by reference, discloses a closure with an injection molded plastic insert inside a metal shell. The plastic insert includes the thread to allow the closure to be screwed to a prethreaded bottle. The outer metal shell serves two functions, first it provides a clean, thread free appearance for the closure. Second, the outer metal shell includes the tamper evident ring or band that is crimped to the container. This closure is applied to a prethreaded bottle by engaging the plastic thread of the insert with the glass thread of the bottle and screwing the closure onto the thread. Subsequently, the tamper evident ring is rolled or crimped to the bottle. U.S. Pat. No. 8,231,019 to Piero Battegazzore filed on Mar. 25, 2008 and entitled “Bottle Closure,” which is hereby incorporated by reference, discloses a similar closure where a metal shell houses a plastic threaded insert.

Beverage companies, for example brewers, use bottle-shaped aluminum containers, also known as bottle cans, to package their products. Aluminum bottle-shaped containers are formed by drawing and ironing a disk of aluminum into an elongated cylindrical shell. The shell undergoes further forming operations to create the shoulder, the neck, and the finish of the container. A thread is formed in the finish portion of the bottle. In addition, a curl is formed to provide a safe surface to allow the consumer to drink directly from the bottle-shaped container. An aluminum closure is applied to the bottle-shaped container using the roll-on pilfer proof process described above. Reducing the amount of aluminum used in the bottle-shaped containers has the potential to considerably reduce packaging costs without affecting the functioning of the bottle-shaped container while maintaining the look and feel to which consumers have become accustomed. The bottle-shaped containers must be able to withstand significant axial loads in order to receive a roll-on pilfer proof closure. U.S. Patent Application Publication No. 2015/0344166 to Daniel Davis et al. filed on May 30, 2014 and entitled Low Spread Metal Elongated Bottle Production and Method,” which is hereby incorporated by reference, discloses an aluminum bottle-shaped container and a process of forming the bottle-shaped container.

### SUMMARY

A method for securing a tamper evident closure to a container includes providing a prethreaded closure that is defined by a top portion and a skirt portion that extends from the top portion. The skirt portion defines an inner closure thread surface and an opposed outer closure thread surface of at least one closure thread. The skirt portion also includes a tamper evident band. The prethreaded closure is rotated to engage the at least one closure thread with at least one container thread of a container. The inner closure thread surface contacts a surface of the at least one container thread. The tamper evident band of the prethreaded closure is rolled to secure the tamper evident band to the container.

Technical advantages of capping a bottle-shaped container with a prethreaded closure according to the teachings of the present disclosure include a reduction in axial force required to cap the bottle-shaped container. By reducing this axial force, the bottle-shaped container may be formed to be less robust than conventional glass or metal bottles in that they are required to resist less axial force without deforming. Raw materials to manufacture such bottle-shaped containers may be less expensive, which provides cost savings to the bottle manufacturer.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE FIGURES

A more complete understanding of the method and apparatus of the present invention may be acquired by reference to the following Detailed Description when taken in conjunction with the accompanying drawings wherein:

FIG. 1 is a perspective view of a blank shell that undergoes additional forming operations to create a prethreaded closure according to the teachings of the present disclosure;

FIG. 2 is a perspective view of a prethreaded closure;

FIG. 3 illustrates a step in a capping process where the prethreaded closure is secured to a filled container;

FIG. 4 shows the closure of FIG. 3 threaded to a container with portions removed and shown in cross-section;

FIG. 5 is an elevation view of a bottle-shaped container with the prethreaded closure of FIG. 3 threaded to the thread of the bottle-shaped container; and

FIG. 6 is a flow diagram of a process of forming a prethreaded closure and securing the closure to a prethreaded container.

### DETAILED DESCRIPTION

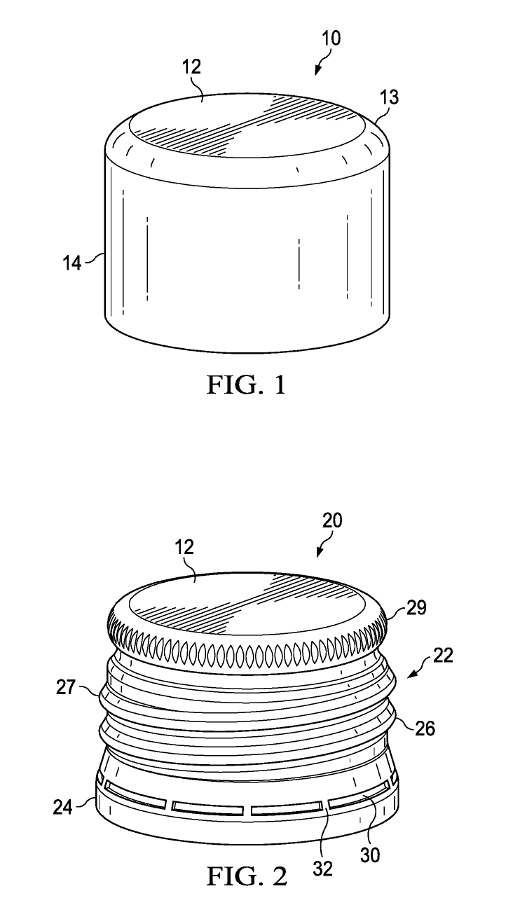

Reference is made to FIG. 1, which is a perspective view of a blank shell 10 according to the teachings of the present disclosure. The blank shell 10 may be made of any suitable metal, such as a stiff metal like steel, or may be made of a softer metal like aluminum. According to an alternate embodiment, the blank shell 10 may be made of plastic and formed according to known polymeric forming processes, such as injection molding. The shell 10 is generally featureless and includes a top portion 12 and a cylindrically-shaped skirt portion 14 extending from the top portion 12. The top portion may include a chamfer 13 in transition to the skirt portion 14. The shell 10 is formed by drawing a generally flat disk of metal, such as aluminum, into the shape of the shell 10. The shell 10 undergoes additional forming operations to become a prethreaded closure that is secured to and seals a threaded container.

Reference is made to FIG. 2, which is a perspective view of a prethreaded closure 20 according to the teachings of the present disclosure. The prethreaded closure 20 includes a cap portion 22 and a tamper-evident band 24 disposed below the cap portion 22. The closure 20 is prethreaded. That is, a spiral thread 26, is formed in the skirt portion 14 prior to securing the prethreaded closure 20 to a threaded container. The cap portion 22 includes the top portion 12, knurling 29, and a spiral thread 26.

The tamper evident band 24 is formed from a lower portion of the skirt. A frangible portion of the skirt 14 is created by discontinuous slits 30 that are made in the skirt 14. Bridges 32 of metal, for example aluminum, that connect the tamper-evident band 24 to the cap portion 22 are disposed between the slits 30. The slits 30 are formed by a forming machine, as discussed further below. According to certain embodiments, a single forming machine may form the slits 30, the knurling 29, and the spiral thread 26. When the closure 20 exits the forming machine, it is ready to be screwed onto a threaded container, such as a bottle-shaped aluminum container, which may also be referred to as a bottle can.

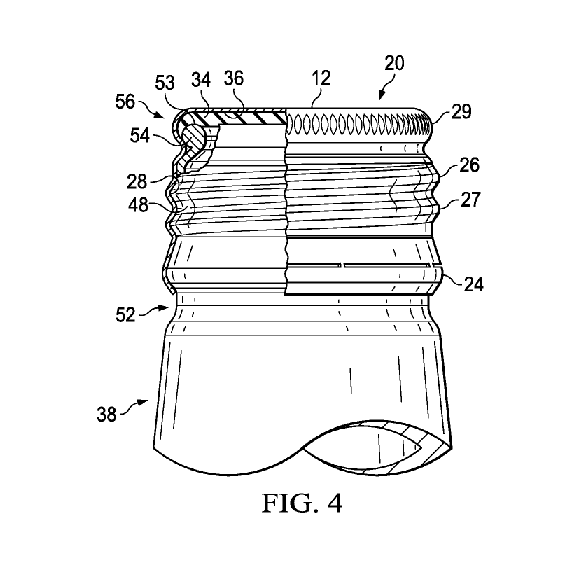

The spiral thread 26, or multiple threads, is formed in the skirt portion 14 above the tamper-evident band 24. The thread 26 is formed using any one of multiple metal forming processes and tooling that shapes the metal to have contours in the shape of the spiral thread 26. Because the thread 26 is formed using metal forming processes applied to a thin metal (i.e. aluminum) shell, for example and aluminum shell, the spiral thread 26 includes an outer thread surface 27 and an opposed inner thread surface 28 (see FIG. 4). The inner thread surface 28 is recessed from the rest of the skirt portion 14, and the outer thread surface 27 is in the form of a projection from the rest of the skirt portion 14.

According to one embodiment, to form the spiral thread 26, a mandrel receives the blank shell 10. The mandrel is formed of a hard material and it includes the negative of the features desired to be formed on shell 10. A punch or other forming device applies forces to the blank shell 10 sufficient to form the metal of the skirt portion 14 in the shape of the negative of the thread of the mandrel. In certain embodiments, the mandrel rotates to allow forming to occur over the entire circumference of the shell. According to other embodiments, the mandrel is stationary, and the punch or other forming device rotates to form the full circumference of the shell 10. In still other embodiments, both the mandrel and the forming device rotate in cooperation to form the features of the closure 20.

After forming the thread 26, the shell 10 is removed from the mandrel. According to one embodiment, the mandrel rotates opposite the forming direction to disengage the formed thread 26 of the shell 10 from the threads of the mandrel. According to an alternate embodiment, a belt uses friction between the outer surface of the shell 10 and the belt surface to rotate the shell to disengage the thread 26 from the mandrel thread.

According to an alternate embodiment, the thread 26 is formed in the skirt portion 14 using tooling other than a mandrel. For example, an outer surface of the skirt portion 14 is operated on by a forming tool, which forms the metal (i.e. aluminum) into the thread 26. In the forming method, the shell 10 may move or rotate and the tool is stationary, or alternatively, the shell 10 remains stationary and the tooling moves. According to yet a further alternate embodiment, one forming disk may be received inside the shell 10 and a second forming disk engages the outer surface of the shell 10. The disks rotate in opposite directions to form the metal to form the thread 26. Alternatively, the shell 10 may rotate and the two opposed forming disk tooling may remain stationary. Disengaging the two forming disks releases the formed shell from the tooling, where the shell, now with the thread 26, may be further formed or otherwise processed.

According to certain embodiments, the thread 26 is a continuous spiral thread that spirals down the skirt portion 14. For example, the spiral thread 26 may extend around the circumference of the skirt portion 14 approximately 2½ times. Thus, in order to twist on or off the closure 20, the closure 20 must make 2.5 revolutions with respect to the threaded container. In other embodiments, the thread 26 may be a plurality of short threads or thread starts that may or may not spirally extend down the skirt. The multiple threads may allow the cap or the closure 20 to be removed from the bottle with less rotation of the closure than the single continuous thread. For example, a series of four threads may each extend approximately a quarter of the circumference of the skirt portion 14 such that a quarter rotation or turn of the closure 20 with respect to the threaded container will engage or disengage the threads of the closure from the corresponding threads of the container to either secure or remove the closure 20 to the threaded container. In this respect, the closure with multiple threads may function similar to a crown-type closure that is known in the art.

Knurling 29 is also formed by deforming an upper-portion of the skirt portion 14 near the junction of the skirt 14 and the top portion 12. The knurling 29 is deformed metal in a pattern to provide a feature that facilitates gripping of the closure 20 to allow a consumer to grasp and twist the closure 20 more easily. The knurling 29 may also facilitate gripping of the closure 20 by the capper head or other machinery associated with the process of capping a filled container or further metal forming of the closure 20. The knurling and slitting of the closure 20 may be performed by a knurling machine available from SACMI of Imola, Italy. An example of a knurling and slitting machine for forming the knurling 29 and the tamper evident band 24 for closures, such as closure 20, is disclosed in U.S. Pat. No. 7,673,543 to Danilo Albonetti, filed on Dec. 27, 2004, and entitled Apparatus for Making a Fracture Cut Between the Cup and the Safety Ring in Plastic Caps,” which is hereby incorporated by reference.

Attention is directed to FIG. 4, which illustrates features internal to the prethreaded closure 20. A liner 34 is secured to an underside surface 36 of the top portion 12. According to one embodiment, the liner 34 is secured to the underside surface 36 after certain features including the slits 30 and the knurling 29 are formed. This may protect the liner 34 from becoming damaged during these forming operations. According to one embodiment, the liner 34 may be formed and applied to the closure using a specially designed machine available from SACMI of Imola, Italy. An example of a liner machine for applying liner to closures, such as closure 20, is disclosed in U.S. Pat. No. 6,718,606 to Giovanni Bassi, filed on Sep. 6, 2002, and entitled Apparatus for Molding and Applying Liners in Caps,” which is hereby incorporated by reference. The liner 34 is in-shell molded to an underside surface 36 of the top portion 12, as discussed in more detail below. According to an alternate embodiment, a preformed disk liner may be inserted into the closure 20 and retained in the closure 20 by a liner retaining ring that is formed in the closure 20 prior to insertion of the disk liner.

In certain embodiments, the liner 34 may also serve an oxygen reducing function by absorbing oxygen that originates in the head space of the container and permeates at least partially through the liner where it can be absorbed by an oxygen scavenger, such as sodium sulfite.

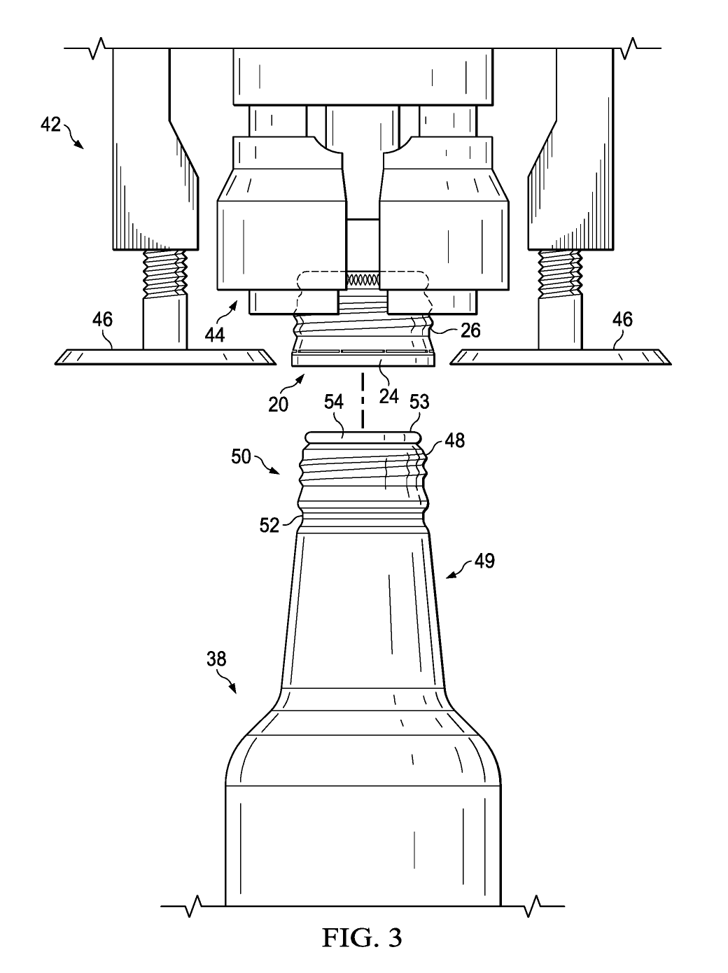

Reference is made to FIG. 3 which illustrates a step in a capping process where the prethreaded closure 20 is secured to a container 38, for example a bottle-shaped aluminum container. FIG. 3 illustrates a portion of a head 42 of a capping machine and an upper portion of the container 38 including a neck portion 49 and a finish portion 50. The finish portion 50 includes a retaining ring 52 that receives the tamper evident band 24, a male container thread 48, and a curl 54 disposed at a mouth of the container 38. A capping machine may include multiple heads, and a filling and capping operation may employ multiple capping machines. The capping machine may be one provided by Zalkin of Montreuil l'Argillé, France, a subsidiary of Pro Mach of Covington, Ky. According to certain embodiments, the capping machine includes one or more Zalkin model VS100 or VS110 capping heads. The capping head 42 is particularly designed to screw on the prethreaded closure 20 and follow the screwing operation with crimping or rolling the tamper-evident band 24 to the container 38.

The prethreaded closure 20 is picked up by the chuck 44 from a star wheel. After picking up the prethreaded closure 20, the head 42 of the capping machine along with the chuck 44 holding the prethreaded closure 20 is lowered onto the container 38. According to an alternate embodiment, the closure 20 may be placed, but not screwed, onto the container upstream of the capping machine 40. According to either embodiment, the chuck 44 and the closure 20 rotate to engage the female threads of the prethreaded closure 20 to the male threads 48 of the container. Along with the rotation of the chuck 44, one or more crimping disks, also referred to as rollers, 46 also rotate with the chuck 44. Once the chuck 44 has performed the number of revolutions, for example 2½, to apply sufficient clamping force to secure the closure 20, more specifically the liner 34 to the container, the chuck 44 stops rotating the closure 20. This may be accomplished by the chuck 44 releasing the grip on the closure 20 or halting the rotation of the chuck 44. The head 42 continues to rotate and the disks or rollers 46 are directed radially inward to apply a radial force to crimp or roll the tamper-evident band 24 to the container 38. Specifically, the tamper-evident band 24 is crimped or rolled into a retaining ring 52 formed in the neck 49 of the container 38 below the container thread 48. According to one embodiment, the retaining ring 52 is an indention around the perimeter of the neck 49 of the container.

Screwing on the prethreaded closure, that is, rotating the closure 20 to engage the closure thread 26 with the container thread 48, requires less axial force on the container 38 than a conventional roll-on application where the closure thread is formed simultaneously with applying the closure to the container. The roll-on application requires that a force be applied to the closure and container combination sufficient to make the seal between the liner and a sealing surface of the curl of the container and maintain that seal while the rollers form the skirt portion to form the thread.

This roll-on thread forming operation is not required with the screwing-on of the prethreaded closure 20 according to the teachings of the present disclosure. Accordingly, the screw-on process can reduce the axial load applied to the closure 20 and container 38 to create a suitable seal between the liner 34 and a sealing surface 53 of the curl 54 of the container 38 to approximately 130 pounds or less. For example, axial forces in a range of 10-140 pounds may create a suitable seal for capping a bottle-shaped aluminum container filled with a carbonated beverage, such as beer. According to one embodiment, an axial force in the range of 40-60 pounds may create a suitable seal for a carbonated beverage container when applied with the screw-on capping process disclosed.

Capping according to the teachings of the present disclosure represents a significant reduction from the 260 to 275 pounds of axial force required to create the liner/mouth seal for the conventional roll-on process. As detailed below, this reduction in axial force may permit certain portions of an aluminum container that is bottle-shaped to be formed of less aluminum because certain portions of the container need not be as strong because the container is required to withstand less axial force during the screw-on capping process of the prethreaded closure 20. In particular, this reduction in axial force permits for the use of bottle-shaped containers having an axial pressure resistance against deformation of less than 275 pounds. According to certain embodiments, the axial pressure resistance against deformation is less than 260 pounds.

Reference is made to FIG. 4, which shows the closure 20 threaded to the container 38 with portions removed and shown in cross-section. The tamper-evident band 24 is crimped to the retaining ring 52 formed in the container 38. Compression of the liner 34, which is formed of resilient material, creates a seal between the prethreaded closure 20 and a sealing surface 53 of the curl 54 of the container 38. In certain embodiments, the container 38 may be a metal, for example aluminum, bottle-shaped container and the curl 54 may be a rolled flange. According to alternate embodiments, the container 38 may be glass or plastic. The seal prevents the beverage from leaking from the container 38 and also retains the carbonation, the CO₂, if the container has been filled with a carbonated beverage, such as beer.

A reform portion 56 of the prethreaded closure 20 creates additional compression of the liner 34 in a generally radial direction in addition to the axial compression of the liner 34. The engagement of the spiral thread 26 of the prethreaded closure 20 with the container thread 48 compresses the liner axially and radially to create the seal. The reform portion 56 is formed using tooling associated with the other metal forming operations performed on the shell 10, such as knurling, forming the slits 30, and or forming the thread 26. The reform portion 56 allows the liner 34 to seal a carbonated beverage, which places the container and the seal under an outward pressure. The reform portion 56 may be omitted when the preformed closure 20 is used to seal a container filled with a still beverage, that is, a beverage that is not carbonated, such as still water.

In certain embodiments, the liner 34 may also include an oxygen scavenger to reduce the oxygen level present in the headspace of the container 38. The oxygen scavenging liner may also absorb oxygen originating outside of the container to prevent ingress of oxygen into the container. An example of a suitable oxygen scavenging liner is disclosed by U.S. Pat. No. 9,248,943, filed on Feb. 18, 2013 and titled “Container Closure,” which is hereby incorporated by reference. The seal between the liner 34 and the sealing surface 53 of the curl 54 is held by the engagement of the female thread 26 of the closure 20 with the male thread 48 of the container 38.

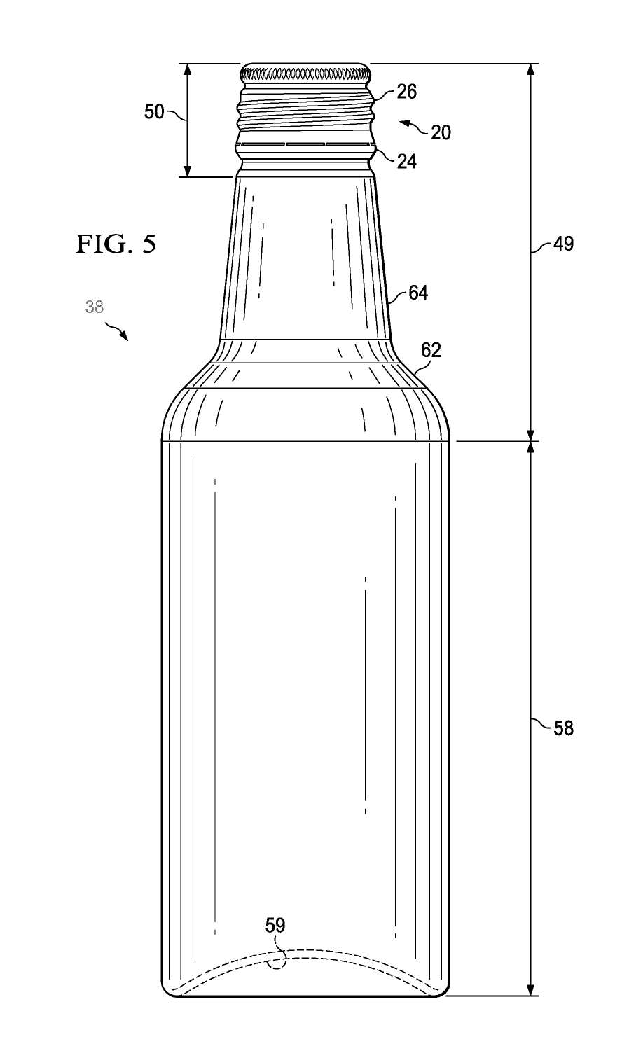

FIG. 5 illustrates an elevation view of the bottle-shaped container 38 with the closure 20 threaded to the bottle-shaped container 38 according to the teachings of the present disclosure and forming a seal between the liner 34 and the sealing surface 53 of the curl 54 of the container 38. (see FIG. 4). The container 38 may be formed of any suitable material. According to certain embodiments, the container 38 is formed of aluminum that has been drawn, ironed, and further shaped into the bottle-shaped configuration shown in FIG. 5. An example of a bottle-shaped container formed from aluminum is disclosed in U.S. patent publication number 2015/0344166, filed on May 30, 2014 and entitled, “Low Spread Metal Elongated Bottle and Production Method,” which is hereby incorporated by reference.

According to certain embodiments, the neck portion 49, which includes a shoulder portion 62, a tapered profile 64, and the finish portion 50 (see FIG. 4), may have less aluminum forming those portions of the container 38 than in a conventional aluminum bottle-shaped container. Other portions of the container including the cylindrical portion 58 and the dome portion 59 may not have reduced aluminum forming these portions. The reduced aluminum in certain portions of the container 38 is possible due to the screwing of the prethreaded closure 20 onto the thread 48 of the container 38 to form the seal between the liner 34 and the sealing surface 53 of the curl 54 of the container 38, which is accomplished with less axial force, than conventional roll-on capping. For example, the screw-on seal may be accomplished with 130 pounds or less of force. According to one embodiment, the aluminum bottle-shaped container 38 may have 8%-50% less aluminum in the top third of the container 38 when the closure is applied with the screw-on process, as opposed to the roll-on process.

According to an alternate embodiment for a light weight container with less aluminum in certain portions, the container 38 may include a neck ring. A neck ring is an annular structure that extends radially from the neck portion 49 proximate the finish portion 50. During capping, either using the conventional roll-on capping process or the screw-on capping process described herein, the capping head receives the neck ring during the capping process. With the neck ring received by the capping head, the neck ring opposes the axial force of the capping head, as opposed to having the whole container 38 oppose the capping force. Greater axial loads may be applied to cap a container with a neck ring that axial loads applied to cap a container without a neck ring because the neck ring opposes the higher axial loads that may otherwise buckle the container or cause other failure modes. A neck ring may be particularly useful on an aluminum container that is unable to withstand the same axial loads as can be withstood by a glass container. An example of a process of capping plastic bottles incorporating a neck ring is described in U.S. Pat. No. 7,552,575 to Wendell S. Martin, which is hereby incorporated by reference.

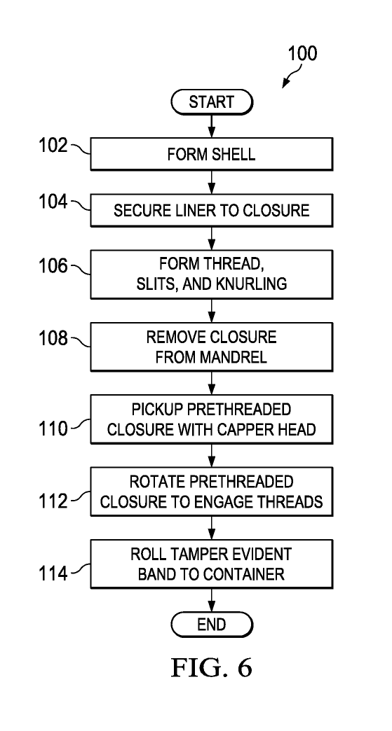

Reference is made to FIG. 6, which is a flow diagram of a process 100 of capping a filled beverage container by screwing on a prethreaded closure 20 to a prethreaded container 38 according to the teachings of the present disclosure. At step 102, a shell 10 is formed from a disk of aluminum or other suitable metal. The shell is generally featureless, such that it includes only a top portion 12 and a cylindrically shaped skirt 14 extending from the top portion 12. In certain embodiments, a chamfer 13 is also formed in the blank shell 10.

At step 104, a liner 34 is secured to the closure 20. A metered amount of the material of the liner 34 is deposited inside the shell 10 on the underside 36 of the top portion 12. Subsequently, a punch spreads and shapes the liner material to the desired shape that is suitable for sealing. The liner 34 is an in-shell molded liner and may be formed using the liner machine provided by SACMI, as detailed above, or any suitable liner machine. The in-shell molded liner 34 is formed in the shell 10 before further metal forming operations because the punch that spreads and shapes the liner material would otherwise damage a closure thread if such closure thread was formed in the skirt portion 14 of the shell 10 prior to the punch entering the shell 10 to spread and shape the liner material.

According to an alternate embodiment, a preformed disk liner is received by the closure 20. A liner retaining ring that has been previously formed in the shell retains the disk liner in position proximate the underside 36 of the top portion 12 where it can create a seal with the sealing surface 53 of the curl 54.

At step 106, certain features are formed in the shell 10. As described above, the blank shell 10, with an in-shell molded liner or without a disk liner, may be placed on a mandrel that has corresponding thread features. A forming press may form the thread 26 of the closure 20 as the mandrel rotates the closure 20. According to an alternate embodiment, the mandrel may maintain the closure 20 stationary while forming disks or rollers 46 or another forming device forms the thread 26 into the skirt 14 of the shell 10. Simultaneously with or sequential to the forming of the thread 26, knurling 29 may also be formed in the closure 20. In addition, slits 30 are made in a lower portion of the skirt 14. The slits 30 may be formed simultaneously with or sequential to either the forming of the thread 26 or the knurling 29. Formation of the slits 30 allows separation of the tamper-evident band 24 from the cap portion 22 of the closure 20 when the cap portion 22 is twisted by the consumer to disengage the thread 26 of the closure 20 from the thread 48 of the container 38 such that the cap portion 22 can be removed and the beverage can be accessed by the consumer. According to certain embodiments, a reform portion 56 may also be formed using appropriate tooling simultaneously or sequentially with the forming of the thread 26, the knurling 29, and/or the slits 30.

At step 108, the closure 20 is removed from the mandrel. This operation includes rotating the mandrel opposite the forming direction to disengage the formed thread 26 of the closure 20 from the thread of the mandrel without damaging the closure thread 26. Alternatively, any of the metal forming operations and removal processes described above may be used to form the features of the prethreaded closure and disengage the formed closure from the tooling. According to some embodiments, the completion of this step may represent a break in the process such that the lined closures are fully formed and fed or otherwise received by a capping machine to be placed onto the filled containers.

At step 110, the prethreaded closure 20 including the thread 26 is picked up by a capper head 42. According to an alternate embodiment, the prethreaded closure 20 may be applied upstream of the capper head 42 such that it is not threaded on the container, but rather rests on the curl 54 of the container 38. By resting on the curl 54 of the container 38, the container 38 can be indexed under a capper head 42 in position for the capper head 42 to be lowered where it can grasp and rotate the prethreaded closure 20.

At step 112, the prethreaded closure 20 is rotated to engage the preformed thread 26 of the closure to the thread 48 of the container 38. The chuck 44 of the capper head 42 rotates with the closure 20, whether the closure 20 is applied to the container 38 upstream or directly lowered on the container 38 by the chuck 44, a suitable number of rotations such that a single spiral thread 26 on the closure is engaged with a corresponding single spiral thread 48 of the container 38. The torqueing of the closure 20 onto the thread 48 of the container 38 also forms the seal between the liner 34 and the sealing surface 53 of the curl 54 of the container 38. According to an alternate embodiment, multiple closure threads engage corresponding multiple container threads to create the clamping force required to make the seal between the liner 34 and the sealing surface 53 of the curl 54.

At step 114, the rotation of the closure 20 halts and the tamper-evident band 24 is rolled or crimped to a retaining ring 52 formed in the container 38. As described above, the crimping disks or rollers 46 may continue to rotate with the head 42 of the capper after the chuck 44 ceases rotation. The rotating crimping disks 46 apply a radial force component to form the tamper-evident band 24 to the container 38, specifically to the retaining ring 52 portion of the container 38. The capping process ends and the capped and filled container proceeds down the fill line to be placed in further packaging suitable for shipping.

Some of the steps illustrated in FIG. 6 may be combined, modified, or deleted where appropriate, and additional steps may also be added to the flowchart. Additionally, steps may be performed in any suitable order without departing from the scope of the disclosure. For example, in an alternate embodiment the shell may be formed, then the knurls and slits are formed, then the liner is deposited in the shell, either an in-shell molded liner or a preformed disk liner, then the reform may be formed on the closure, and finally the thread may be formed in the skirt.

Containers capped with a prethreaded closure according to the teachings of the present disclosure may present an attractive looking package of an aluminum bottle-shaped container that is easily gripped by the consumer. In addition, the aluminum used for the container can be significantly reduced because the container is not required to withstand axial forces associated with maintaining a seal between a liner and a sealing surface of a container finish while a thread is formed in the closure. Rather, rotating a closure with preformed threads allows the seal to be made by torqueing the closure and engaging the threads of the closure with the threads of the container. The torqueing of the closure to engage the threads creates the clamping force to make the seal between the liner and the mouth of the container and less axial force is required.

The embodiments disclosed herein also increase recyclability of the closures by being formed of a single metal material along with the resilient liner material. With conventional closures that rely on plastic inserts for the closure thread, the recyclability of such closures is reduced because the plastic insert tends to contaminate the aluminum stream. The plastic inserts are generally not recycled and must be separated from the aluminum of the closure. Disposal of the plastic material includes burning the plastic material in a furnace, which may be considered less environmentally friendly.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below,” “top” and “bottom” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A prethreaded closure, comprising:
a top portion defining an underside surface;
a skirt portion extending from the top portion, the skirt portion having at least one thread formed therein, the at least one thread forming an inner thread surface and an outer thread surface;
the skirt portion defining a frangible portion;
a band extending below the frangible portion and disposed aligned with the skirt portion, the band having a diameter sized to fit over a mouth of a bottle-shaped container.

2. The prethreaded closure of claim 1 wherein the frangible portion comprises a plurality of slits separated from each other by a bridge.

3. The prethreaded closure of claim 1 wherein the at least one thread is only one spiral thread.

4. The prethreaded closure of claim 3 wherein the only one spiral thread extends approximately 2.5 times around the skirt portion.

5. The prethreaded closure of claim 1 wherein the at least one thread is a plurality of threads.

6. The prethreaded closure of claim 1 further comprising a sealing liner formed of a resilient material secured to the underside surface of the top portion.

7. The prethreaded closure of claim 1 further comprising knurling formed in the skirt portion.

8. The prethreaded closure of claim 1 further comprising a reform portion disposed axially between the top portion and the skirt portion.

9. The prethreaded closure of claim 1 wherein the prethreaded closure is formed of metal.

10. The prethreaded closure of claim 1 wherein the prethreaded closure is formed of aluminum.

11. The prethreaded closure of claim 1 wherein the band is configured to be crimped to a neck portion of the bottle-shaped container.

12. A beverage container, comprising:
a bottle-shaped container defining a finish portion and a cylindrical portion, the finish portion defining a curl and at least one container thread;
a prethreaded closure, comprising:
a top portion defining an underside surface;
a sealing liner secured to the underside surface;
a skirt portion extending from the top portion and defining at least one closure thread engaged with the at least one container thread;
a frangible portion; and
a tamper-evident band extending below the frangible portion and crimped to the finish portion of the bottle-shaped container; and
wherein a torque creates a seal between the sealing liner and the curl of the bottle-shaped container.

13. The beverage container of claim 12 wherein the bottle-shaped container and the prethreaded closure are formed of metal.

14. The beverage container of claim 13 wherein the metal is aluminum.

15. The beverage container of claim 12 wherein the bottle-shaped container has a volume of approximately twelve fluid ounces.

16. The beverage container of claim 15 wherein the bottle-shaped container has an axial pressure resistance against deformation of less than 275 pounds.

17. A method of capping a container, comprising:
providing a bottle-shaped container defining a finish portion and a cylindrical portion, the finish portion defining a curl and at least one container thread;
providing a prethreaded closure, comprising:
a top portion defining an underside surface;
a skirt portion extending from the top portion and defining at least one closure thread forming an inner thread surface and an outer thread surface;
a frangible portion; and
a tamper-evident band extending below the frangible portion;
rotating the prethreaded closure to engage the at least one closure thread with the at least one container thread, the inner thread surface contacting a surface of the at least one container thread; and
rolling the tamper evident band of the prethreaded closure to secure the tamper evident band to the finish portion.

18. The method of claim 17 wherein the at least one closure thread is only one continuous spiral thread extending about 2.5 times around a circumference of the skirt portion and wherein the prethreaded closure is rotated about 2.5 times to engage the only one continuous spiral thread to the at least one container thread.

19. The method of claim 17 wherein the prethreaded closure further comprises a sealing liner secured to the underside surface and rotating the prethreaded closure to engage the at least one closure thread applies an axial force in a range of 10-140 pounds to the bottle-shaped container to form a seal between the sealing liner and the curl.

20. The method of claim 19 wherein the applied axial force is in a range of 40-60 pounds.

21. The method of claim 17 wherein the bottle-shaped container and the prethreaded closure including the at least one closure thread are formed of metal.

22. The method of claim 21 wherein the metal is aluminum.

23. The method of claim 17 further comprising placing a disk liner proximate the underside surface of the top portion.

24. The method of claim 17 further comprising in-shell molding a liner to the underside surface of the top portion.

25. A kit in parts comprising:
(a) a beverage container, comprising:
a bottle-shaped container defining a finish portion and a cylindrical portion, the finish portion defining a curl and at least one container thread; and
(b) a prethreaded closure, comprising:
a top portion defining an underside surface;
a skirt portion extending from the top portion, the skirt portion having at least one thread formed therein, the at least one thread forming and outer thread surface and an inner thread surface, the skirt portion configured to cooperate with the finish portion of the bottle-shaped container;
the skirt portion defining a frangible portion; and
a band extending below the frangible portion and disposed aligned with the skirt portion, the band having a diameter sized to fit over the finish portion of the bottle-shaped container.

26. The kit in parts of claim 25, the beverage container having an axial pressure resistance against deformation of less than 275 pounds.

27. The kin in parts of claim 26 wherein the axial pressure resistance against deformation is less than 260 pounds.

28. The kit in parts of claim 25, wherein the beverage container and prethreaded closure are formed of metal.

29. A kit in parts comprising:
(a) a beverage container, comprising:
a bottle-shaped container defining a finish portion and a cylindrical portion, the finish portion defining a curl and at least one container thread; and
(b) a prethreaded closure, comprising:
a top portion defining an underside surface;
a skirt portion extending from the top portion, the skirt portion having at least one thread formed therein, the at least one thread forming an inner thread surface configured to cooperate with the at least one container thread of the bottle-shaped container;
wherein the top portion, the skirt portion, and the at least one thread are all formed in a single material;
the skirt portion defining a frangible portion; and
a band extending below the frangible portion and disposed aligned with the skirt portion, the band having a diameter sized to fit over the finish portion of the bottle-shaped container.

30. A kit in parts comprising:
(a) a beverage container, comprising:
a bottle-shaped container defining a finish portion and a cylindrical portion, the finish portion defining a curl and at least one container thread, the bottle-shaped container having an axial pressure resistance against deformation of less than 275 pounds; and
(b) a prethreaded closure, comprising:
a top portion defining an underside surface;
a skirt portion extending from the top portion, the skirt portion having at least one thread formed therein, the at least one thread forming an inner thread surface configured to cooperate with the at least one container thread of the bottle-shaped container;
the skirt portion defining a frangible portion; and
a band extending below the frangible portion and disposed aligned with the skirt portion, the band having a diameter sized to fit over the finish portion of the bottle-shaped container.

31. The kit in parts of claim 30 wherein the axial pressure resistance against deformation is less than 260 pounds.
